(19) United States
(12) Patent Application Publication
(10) Pub. No.: US 2018/0218461 A1
(43) Pub. Date: Aug. 2, 2018

(54) MEAL-KIT MENU DEVELOPMENT SYSTEM

(71) Applicant: Relish Labs, LLC, Chicago, IL (US)

(72) Inventors: Matt Pulley, Chicago, IL (US); Erik Jensen, Chicago, IL (US)

(21) Appl. No.: 15/636,285

(22) Filed: Jun. 28, 2017

Related U.S. Application Data
(60) Provisional application No. 62/452,768, filed on Jan. 31, 2017.

(51) Int. Cl. G06Q 50/12; G06Q 30/02; G06Q 30/06

(52) U.S. Cl. CPC G06Q 50/12; G06Q 30/0643; G06Q 30/0246; G06Q 30/0243

(57) ABSTRACT

The disclosed systems evaluate user responses to various potential meal-kit menu designs and isolate variables having an impact on customer conversion, enabling a meal-kit company to select more effective meal-kit menus and to avoid waste associated with inaccurately predicting demand for meal-kits.

### CROSS-REFERENCE TO RELATED APPLICATION

This application claims priority to and benefit of U.S. Provisional Application Ser. No. 62/452,768, which was filed on Jan. 31, 2017 and is titled “Meal-Kit Menu Development System,” the entire disclosure of which is expressly incorporated herein by reference.

### TECHNICAL FIELD

The present disclosure generally relates to displaying a meal-kit menu at an electronic device and, more particularly, to techniques for improving the meal-kit menu design and development process.

### BACKGROUND

While many people appreciate a home-cooked meal, they often lack the time, energy, or skill needed to consistently plan meals, shop for the necessary ingredients, and prepare the meals. As a result, busy families often turn to restaurants and prepackaged food when making plans for dinner. In recent years, however, an increasingly popular alternative has arisen, enabling these busy families to more consistently enjoy home-cooked meals: meal-kits.

Generally speaking, a meal-kit includes a set of ingredients for a meal and a set of instructions for preparing that meal. Meal-kit companies normally operate on a weekly schedule. In a typical example, a customer selects the meal-kits he wants for a week. The meal-kit company then packs the ingredients for the selected meal-kits into a box and ships the box to the customer. After receiving the box, the customer places the meal-kit ingredients in his or her refrigerator, where he or she can later retrieve them when preparing a meal (with the aid of the corresponding instructions). The meal-kits not only save the customer time and energy that would have been spent planning meals and shopping for groceries; they familiarize the customer with various new foods and meal preparation techniques, expanding the culinary skills of someone who might otherwise avoid cooking entirely.

To facilitate meal-kit selection, most meal-kit companies provide customers with a preselected menu of meal-kit options from which customers can choose. These meal-kit options are first suggested by employees based on the seasonality and availability of ingredients, as well as guesses as to what customers may desire.

### SUMMARY

Generally speaking, the disclosed systems may evaluate user responses to various potential meal-kit menu designs and may isolate variables having an impact on customer conversion, enabling a meal-kit company to select more effective meal-kit menus and to thus: (i) improve customer experience and thereby improve sales of meal-kits, and (ii) avoid waste associated with inaccurately predicting demand for meal-kits.

Regarding improving the customer experience, systems disclosed herein enable meal-kit companies to consistently publish meal-kit menus that will engage customers and lead to meal-kit sales. That is, some of the disclosed systems facilitate a testing process that can remove much of the guess-work typically associated with trying to develop a meal-kit menu that will lead to sales, allowing meal-kit companies to confidently publish a meal-kit menu knowing it will likely engage customers and improve sales of meal-kits.

Regarding avoiding waste, systems disclosed herein enable meal-kit companies to more efficiently manage the logistics associated with preparing and selling meal-kits. For example, when a meal-kit company chooses a final menu, it must predict the sales for each meal-kit. The meal-kit company relies on these predictions to purchase and store perishable ingredients used for the meal-kits. If the predictions are low for a given meal-kit, the company will prematurely sell-out and lose potential sales they might have enjoyed if they had properly predicted demand. On the other hand, if the predictions are high, the company will purchase and store too many ingredients. Because many of these ingredients are perishable, they will be unusable after a period of time. Generally, meal-kit companies simply destroy perished ingredients, which translates to a waste of money and labor spent purchasing, preparing, and storing the destroyed ingredients. By accurately predicting demand, waste (both in terms of lost potential sales and in terms of lost resources associated with over-purchasing) can be avoided. In sum, the ability to accurately predict demand for potential meal-kit menus helps meal-kit companies to select more effective meal-kit menus and to avoid waste associated with inaccurately predicting demand.

### BRIEF DESCRIPTION OF THE DRAWINGS

Each of the figures described below depicts one or more aspects of the disclosed systems and methods. Where appropriate, the detailed description refers to reference numerals included in the following figures.

FIG. 1 is a software architecture diagram depicting an example meal-kit menu development and ordering system that can be utilized to design, edit, test, and finalize meal-kit menus for customers to view and use to purchase meal-kits.

FIG. 2A is a screenshot of a browser window displaying a final menu that may be designed, evaluated, and published by the meal-kit menu development and ordering system.

FIG. 2B is a screenshot of a browser window displaying a recipe page associated with the final menu depicted in FIG. 2A.

FIG. 3 is a data relationship diagram depicting: (i) data associated with an example menu variant; and (ii) data associated with an example meal-kit card 350.

FIG. 4 depicts example menu variants that may be displayed via the customer client depicted in FIG. 1.

FIG. 5 is a block diagram of an example host for the meal-kit menu editor, the meal-kit evaluator, and/or the web order server of the system depicted in FIG. 1.

FIG. 6 is a block diagram of a host for the respondent client and/or the customer client of the system depicted in FIG. 1.

### DETAILED DESCRIPTION

As noted in the summary, the disclosed systems may evaluate user responses to various potential meal-kit menu designs and may isolate variables having an impact on customer conversion, enabling a meal-kit company to select more effective meal-kit menus and to thus: (i) improve customer experience and thereby improve sales of meal-kits, and (ii) avoid waste associated with inaccurately predicting demand for meal-kits.

To evaluate potential menus, a number of “menu variants” are designed and sent to one or more respondent clients, where the menu variants are displayed. At each respondent client, a user selects which of the advertised meal-kits he or she might purchase. The selections by the users may then be analyzed according to a conversion metric to select the most effective menu variant as a “final menu.” In some instances, a new “final menu” is constructed based on knowledge gained regarding particular “menu elements” having the most impact on customer selections.

As used herein, the phrase “conversion metric” refers to a standard of measurement for measuring demand associated with a menu variant. For example, the conversion metric may be the total number of meal-kits selected. As another example, the conversion metric may be the total sales revenue for the selected meal-kits. In yet another example, the conversion metric may be the total profit for the selected meal-kits. Further, the conversion metric may be some hybrid of these measurements. Note, menu variants with the best total sales value may not always have the best total profit value. For example, the menu variant with the best total sales value may be driven by selections of meal-kits that have a low profit margin.

As used herein, the phrase “menu variant” refers to a meal-kit menu that can be displayed to a user via an electronic display to advertise one or more meal-kits. Each menu variant includes one or more “menu elements” that form the menu variant.

As used herein, the phrase “menu element” refers to any suitable piece of content (e.g., images, text, audio, video) that might be presented (e.g., via a display) to an end-user as part of a menu variant. A given menu element may represent, for example, an advertisement, a message to a consumer, or background colors and borders. In some instances, a menu element may comprise other menu elements (sometimes referred to as sub-elements). To illustrate, an example menu element is a “meal-kit card” advertising a particular meal-kit. A meal-kit card may include one or more images (e.g., of food in the advertised meal-kit) and/or one or more pieces of text (e.g., the name of the meal-kit and/or a description of the meal-kit).

Different menu variants may include distinct sets of menu elements, and may consequently differ from one another. For example, a given pair of menu variants may differ in that each advertises a different set of meal-kits. As another example, a given pair may advertise the same set of meal-kits, but may advertise the set of meal-kits in a different way. For example, the given pair may differ in the layout or order of the meal-kits advertised. In some instances, a given pair may only differ by a single image or description associated with an advertised meal-kit. By utilizing different combinations of menu elements, numerous menu variants can be designed. Typically, it might be difficult to estimate which of these numerous menu variants might best engage a customer and result in meal-kit sales. However, as further described below, the disclosed systems evaluate user interactions with multiple menu variants, enabling selection or design of a final menu that will likely perform better than an untested menu designed based on intuition and guesswork regarding customer behavior.

### I. An Example Meal-Kit Menu Development and Ordering System

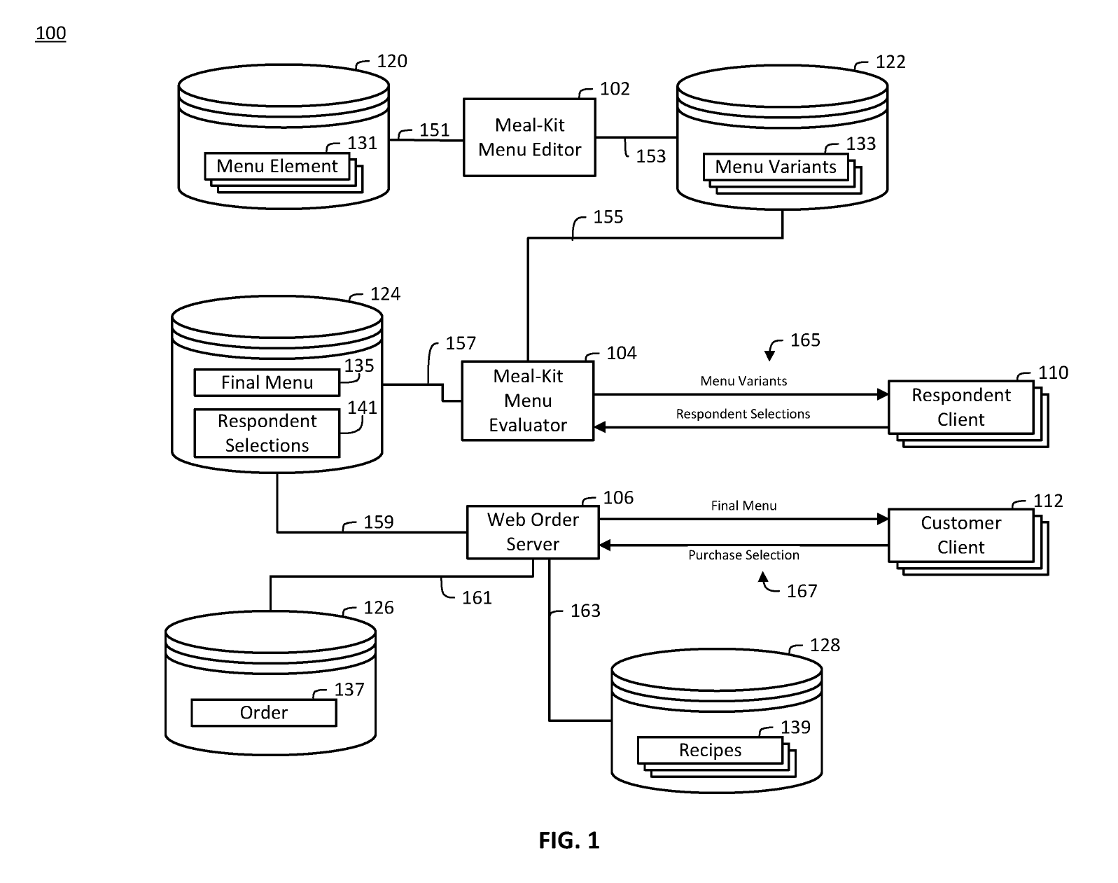

FIG. 1 is a software architecture diagram depicting an example meal-kit menu development and ordering system 100 that can be utilized to design, edit, test, and finalize meal-kit menus for customers to view and use to purchase meal-kits. In particular, the system 100 can present different menu variants to survey respondents and receive feedback from the respondents with respect to which advertised meal-kits they might purchase. Based on this feedback, the system 100 can select the most effective or best performing menu variant as the “final menu” to be published. Alternatively, based on the feedback, the system 100 can generate (or facilitate design of) a new “final menu” including menu elements that best encouraged respondents to select meal-kits. Accordingly, the system 100 enables meal-kit operators to publish a final menu that will likely outperform a menu published without an objective evaluation of customer interactions with menus.

The system 100 may include one or more of the modules 102-112, each of which is an executable set of instructions that makes up a software application, routine, or subroutine. Each of the modules 110 and 112 (which may also be referred to as “clients” or “client modules”) may be a thick client (e.g., a specially programmed application relying heavily on locally stored data and other resources), a thin client (e.g., a web client or browser), or a hybrid client. While the following discussion generally refers to a single respondent client 110 and a single customer client 112, it will be understood that the system 100 may include multiple respondent clients 110 and may include multiple customer clients 112.

The modules 102-112 may include: a meal-kit menu editor 102, a meal-kit evaluator 104, a web order server 106, one or more respondent clients 110 (sometimes referred to as “respondent(s) 110”), and one or more customer clients 112 (sometimes referred to as “customer(s) 112”). The meal-kit menu editor 102 is communicatively coupled (i) via a communication link 151 to a database 120 storing menu elements 131 and (ii) via a communication link 153 to a database 122 storing menu variants 133. The meal-kit evaluator 104 is communicatively coupled (i) via a communication link 155 to the database 122, (ii) via a communication link 157 to a database 124 storing a final menu 135 and respondent selections 141, and (iii) via a communication link 165 to the respondent client(s) 110. The web order server 106 is communicatively coupled (i) via a communication link 159 to the database 124, (ii) via a communication link 167 to the customer client(s) 112, (iii) via a communication link 161 to a database 126 storing an order 137, and (iv) via a communication link 163 to a database 128 storing recipes 139.

Each database 120-128 is a collection of data stored at a physical memory of any suitable computing device. Each of the communication links 151-167 is a logical pathway over which information is transferred between two or more nodes (e.g., between two or more modules 102-112 and/or databases 120-128). The nature of these communication links is described in more detail in the “Additional Considerations” section. Below, example operation of the meal-kit menu editor 102, the meal-kit menu evaluator 104, and the web order server 106 is described.

A. Example Operation of the Meal-Kit Editor 102

In operation, the meal-kit menu editor 102 displays a tool or interface for designing and editing the menu variants 133 using one or more of the menu elements 131. To design one of the menu variants 133, a user interacts with the editor 102 to select various menu elements 131 (retrievable by the editor 102 from the database 120) to be included in the variant 133. As already noted, a menu element 131 can be any suitable piece of content (e.g., images, text, audio, video) that might be presented (e.g., via a display) to an end-user. One or more of the menu elements 131 may be meal-kit cards that include one or more images (e.g., of food in the meal-kit) and/or one or more pieces of text (e.g., the name of the meal-kit and/or a description of the meal-kit). After a menu variant 133 has been designed, the editor 102 stores it to the database 122.

B. Example Operation of the Meal-Kit Evaluator 104

Generally speaking, the meal-kit evaluator 104 may: (i) conduct a survey of the menu variants 133 by sending the menu variants 133 to one or more respondent clients 110, where respondents select advertised meal-kits they would purchase, (ii) analyze the results of the survey, and (iii) select or generate the final menu 135 (and/or facilitate user selection or generation of the final menu 135) based on the analysis. In performing the evaluation of the menu variants 133, the meal-kit evaluator 104 may implement any generally known A/B testing technique.

In example operation, the evaluator 104 retrieves from the database 122 the menu variants 133 generated by the editor 102 and transmits the menu variants 133 to the respondent client 110. The respondent client 110 receives the menu variants 133 and displays them to a user (sometimes referred to as a “respondent”). For each menu variant 133, the respondent selects which of the meal-kits advertised in the displayed menu variant 133 he or she would purchase. The respondent client 110 may make a record of these selections and transmit the respondent selections to the evaluator 104.

Note, in an embodiment, the menu variants 133 are transmitted to multiple respondent clients 110. In an embodiment, multiple copies of each menu variant 133 may be sent to respondent clients 110. Further, in an embodiment, the menu variants 133 (which may include copies of individual menu variants 133) may be dispersed such that each respondent client 110 receives only a single menu variant 133. In an embodiment, each respondent client 110 receives and reviews a menu variant 133 without knowledge of any of the other menu variants 133.

The evaluator 104 receives the respondent selections from the client 110 and may store them to the database 124 as the respondent selections 141. The evaluator 104 analyzes the respondent selections 141 to calculate a value of a conversion metric for each menu variant 133, which the evaluator 104 may utilize to select a menu variant 133 as the final menu 135 or to generate a new menu that is stored to the database 124 as the final menu 135 (or to facilitate a user selecting or designing the final menu 135). As explained at the beginning of the detailed description, the conversion metric may be any suitable standard of measurement for measuring demand associated with the menu variants 133 (e.g., meal-kit sales volume, meal-kit sales revenue, meal-kit profit, etc.).

The evaluator 104 may analyze the conversion metric values associated with each menu variant 133 to identify the most effective variant(s) 133 and/or most effective menu elements 131. The menu variants 133 may be analyzed in pairs to enable the evaluator 104 to isolate one or more variables that might explain a difference in demand for one menu variant 133 versus another. For example, a pair of menu variants 133 may differ only in a background color or font displayed. By analyzing such a pair, the evaluator 104 can attribute a better conversion metric value for a given one of the pair to the corresponding background color or font (because the pair of variants 133 is otherwise identical). As another example, a pair of menu variants 133 may be identical aside from a single meal-kit that has been advertised in place of another. Such a pair may be analyzed to identify which of the advertised meal-kits results in a better conversion metric value. In this fashion, the respondent selections for any number of distinct pairs of menu variants 133 may be compared to one another to isolate variables. Example variables that might be isolated by the evaluator 104 include menu elements 131 (e.g., images, text, price, etc.) and layouts of the menu elements 131 (e.g., the number of meal-kit cards in a row and/or column, the total number of meal-kit cards in a variant 133, the total number of advertisements in a variant 133, the location and/or size of advertisements and/or meal-kit cards, etc.).

Note, the respondent selections 141 may correspond to multiple respondent clients 110. In some instances, the menu variants 133 (which may include duplicate copies of one or more individual menu variants) may be dispersed such that each of the respondent clients 110 receives only a single menu variant 133. Thus, in some instances, the evaluator 104 may analyze respondent selections 141 corresponding to a large number of respondent clients 110.

In some instances, the menu variants 133 transmitted to the respondent client(s) 110 and analyzed by the evaluator 104 include nothing but a single meal-kit card. In such instances, the evaluator 104 can identify a set of high performing meal-kit cards before evaluating other aspects like the potential layout of the meal-kit cards.

After the respondent selections 141 have been analyzed, the evaluator 141 may select the most effective menu variant 133 to be the final menu 135. Alternatively, the evaluator 141 may generate a new menu and store that menu as the final menu 135. The new menu may be generated by identifying high performance variables (as described above) and constructing the new menu variant utilizing those high performance variables (e.g., a set of high performance meal-kit cards arranged according to a high performance layout). In some instances, the evaluator 104 may display a statistical summary of the analysis of the respondent selections 141. A user may utilize this statistical summary to select or generate the final menu 135 herself. In any event, once the final menu 135 has been selected or generated, the evaluator 104 stores the final menu 135 to the database 124.

C. Example Operation of the Web Order Server 106

Generally speaking, the web order server 106 publishes the final menu 135 to make it available to one or more customer clients 112, and receives from the customer clients 112 purchase selections of meal-kits advertised on the final menu 135. The web order server 106 may be said to provide a digital storefront to one or more of the customer clients 112 to facilitate the shopping interaction between the system 100 and the end-user.

The server 106 may publish the final menu 135 by transmitting data representing the final menu 135 to the customer client(s) 112. One or more of the customer clients 112 may be browsers that retrieve the published menu when a user navigates the browser to the appropriate web page. In some instances, one or more of the customer clients 112 may be applications for personal electronic devices, such as phones or tablets. Regardless of the exact nature of the customer clients 112, the customer clients 112 may display the final menu 135. The users of the customer clients 112 may then select for purchase one or more meal-kits advertised in the final menu 135. The client 112 may transmit the user's purchase selections to the web order server 106.

After the server 106 receives the user's purchase selections, the server 106 may generate the order 137, which represents the user's purchase selections. One or more employees may prepare the order 137 for shipping by viewing the order 137 via the server 106 (or via a system communicatively connected to the server 106) and by viewing recipes 139 (which may list the necessary ingredients) for the meal-kits in the order 137. The employees can then retrieve the appropriate ingredients for the meal-kits in the order 137 and package the ingredients for shipping.

Note, the database 126 may maintain the order 137 and the final menu 135 for a future analysis. Meal-kit companies often change menus fairly frequently (e.g., once a week). Accordingly, the system 100 may track historical records or purchase selections for given menus 135 and may analyze those purchase selections and menus 135 in a manner similar to that discussed with respect to the respondent selections 141 and menu variants 133. Consequently, the system 100 can utilize two statistical analyses when developing a final menu 135: (i) a first analysis of respondent selections associated with the menu variants 133, and (ii) a second analysis of purchase selections associated with published menus 135. In short, if a given meal-kit advertised on a published menu 135 is very popular with customers one week, the development of future menus 135 will account for that fact.

While FIG. 1 does not depict the computing devices or hosts that implement the modules 102-112 and databases 120-128, it will be understood that the modules 102-112 and databases 120-128 may be implemented by any suitable number of hosts or computing devices. For example, in an embodiment, each of the modules 102-112 and databases 120-128 is implemented by a different computing device. In other implementations, some combination of the modules 102-106 and/or databases 120-128 are implemented by a same host or computing device. Similarly, the modules 110 and 112 may be implemented by a same computing device or by two different computing devices.

Note, a host implementing the meal-kit menu editor 102 may be referred to as a “meal-kit menu editing device,” a “meal-kit menu editing system,” or something similar; a host implementing the meal-kit evaluator 104 may be referred to as a “meal-kit menu evaluating device,” a “meal-kit menu evaluating system,” a “meal-kit menu evaluation system,” or something similar; and a host implementing the web order server 106 may be referred to as a “web order device,” a “web order system,” or something similar.

### II. An Example Published Final Menu

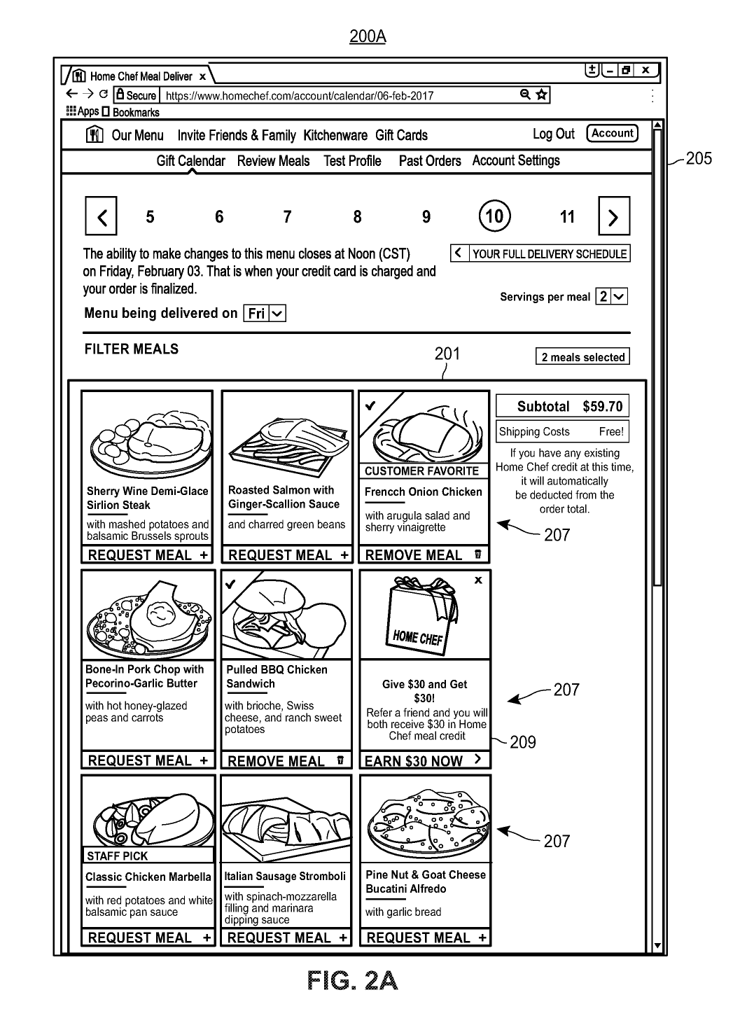

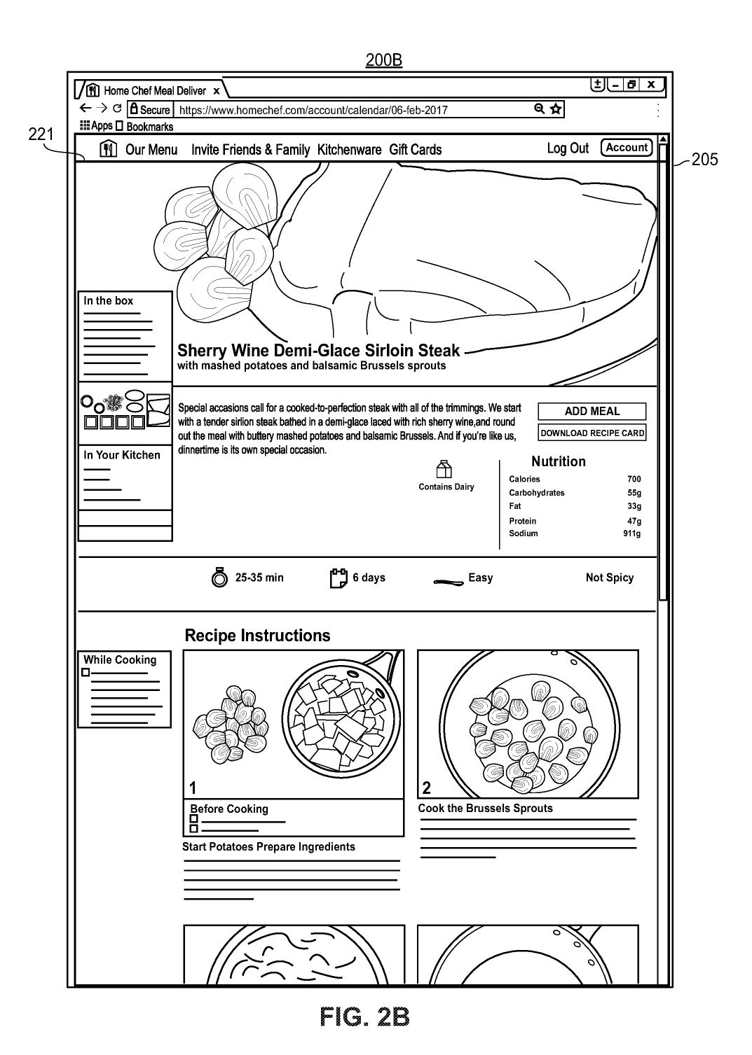

FIG. 2A is a screenshot 200A of a browser window 205 displaying a final menu 201 that may be designed, evaluated, and published by the system 100. The final menu 201 may be displayed by the customer client 112 of the system 100, and represents both an example menu variant 133 and an example final menu 135. The menu 201 includes meal-kit cards 207 that a user may interact with to view more information about a meal-kit or order the meal-kit. As shown, the menu variant 201 also includes an advertisement 209.

The meal-kit cards 207 are examples of the menu elements 131 shown in FIG. 1. As can be seen, each meal-kit card 207 corresponds to a particular meal-kit. For example, the meal-kit cards 207 in the top row correspond to meal-kits titled “Sherry Wine Demi-Glace Sirloin Steak,” “Roasted Salmon with Ginger-Scallion Sauce,” and “French Onion Chicken.” Further, each meal-kit card 207 includes multiple menu elements, such as an image of the meal-kit, a title for the meal-kit, a description for the meal-kit, and a button label “request meal.”

In some instances, a meal-kit card 207 may include “meal facts” such as time to prepare, a difficult level (e.g., easy, medium, hard), and/or a spice level. Further, the meal-kit card 207 may include additional or alternative images, like an image of all of the meal-kit ingredients laid out prior to preparation.

In some instances, interacting with a meal-kit card 207 causes the browser window 205 to display a recipe page 221, as shown in FIG. 2B. Like the final menu 201 shown in FIG. 2A, the recipe page 221 includes a number of menu elements. For example, the recipe page 221 includes a description of what is included in the meal-kit box, a title, a cost per serving, a list of things a person would need from his or her own kitchen to prepare the meal, a category identifier for the meal-kit (e.g., calorie-conscious, carb-conscious, contains gluten, contains dairy, contains soy, contains shellfish, contains nuts, vegetarian), a button to add the meal-kit to a shopping cart, a button to download a recipe card, the meal-facts described with reference to FIG. 2A, and detailed recipe instructions with corresponding images for each stage of the instructions.

Depending on the embodiment, a recipe page associated with a meal-kit card may include more or fewer menu elements than those included in the recipe page 201. Further, in some instances, the menu variant 201 may include more or fewer meal-kit cards 207, and/or more or fewer advertisements 209.

III. Example Data Associated with a Menu Variant and a Meal-Kit Card

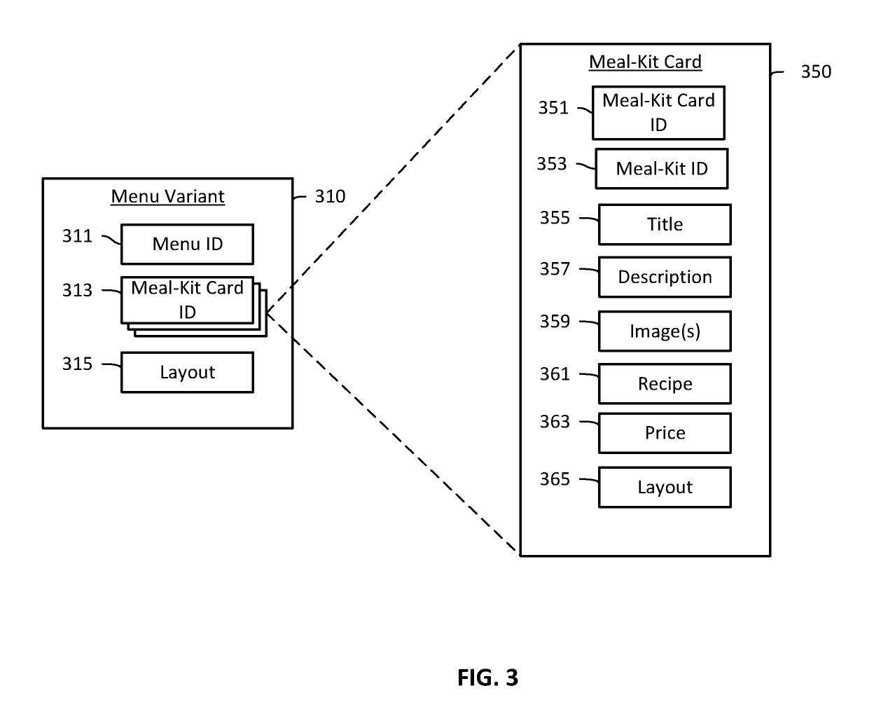

FIG. 3 is a data relationship diagram depicting: (i) data associated with a menu variant 310, which represents an example menu variant 133 of the system 100; and (ii) data associated with a meal-kit card 350, which represents an example menu element 131 of the system 100. The meal-kit card 350 may be similar to the meal-kit cards 207 shown in FIG. 2.

The menu variant 310 includes or references a menu ID 311, one or more meal-kit card IDs 313, and a layout 315. The menu ID 311 is a unique identifier that enables the editor 102 and evaluator 104 to identify the menu variant 310 from other menu variants and to store, sort, and manipulate the menu variant 310. The menu ID 311 can be any suitable variable type, such as a string, float, or integer.

Each of the meal-kit card IDs 313 is an identifier uniquely associated with a particular meal-kit card included in the menu variant 310. Thus, there exists a single unique menu ID 311 for the menu variant 310, as well as a unique meal-kit card ID 313 associated with every meal-kit card included in the menu variant 310. Each meal-kit card ID 313 can be any suitable variable type, such as a string, float, or integer.

The layout 315 is a data-set specifying the spatial layout of the menu elements (e.g., the meal-kit cards) in the menu variant 310. For example, the layout 315 may specify a grid or list format for displaying the meal-kit cards (e.g., a number of rows and/or columns); an order in which the meal-kit cards and other menu elements are displayed; a size of one or more of the menu elements in the menu variant 310; etc. The evaluator 104, server 106, client 110, and/or client 112 may reference the layout 315 to render the menu variant 310 when it is displayed.

The meal-kit card 350 includes or references: a meal-kit card ID 351, a meal-kit ID 353, a title 355, a description 357, an image 359, a recipe 361, a price 363, and a layout 365.

The meal-kit card ID 351 corresponds to one of the meal-kit card IDs 313. That is, the meal-kit card IDs 313 include unique identifiers corresponding to multiple meal-kit cards. The meal-kit card 350 represents one of those multiple meal-kit cards. The meal-kit card ID 351 is unique to the meal-kit card 350, and may be any suitable variable type, such as a string, float, or integer.

The meal-kit ID 353 is a unique identifier for a particular meal-kit. The meal-kit ID 353 may be useful because any given meal-kit may have a plurality of meal-kit cards that could be used to advertise the meal-kit. Because other meal-kit cards may be used for a meal-kit, the meal-kit card ID 351 does not necessarily uniquely identify a meal-kit. In some instances, the evaluator 104 may reference the meal-kit ID 353 to identify a set of meal-kit cards for a particular meal-kit. The evaluator 104 may evaluate the set of meal-kit cards based on respondent selections to identify the best performing meal-kit card for the particular meal-kit.

The title 355 is text (e.g., a string) for a title of the meal-kit card 350. The evaluator 104, server 106, client 110, and/or client 112 may reference the title 355 to display the title of the meal-kit card 350 during an evaluation or during a meal-kit shopping session when the meal-kit card 350 is included in a published final menu.

Similarly, the description 357 is text (e.g., a string) for a description of the meal-kit associated with the meal-kit card 350. The evaluator 104, server 106, client 110, and/or client 112 may reference the description 357 to display the description of the meal-kit during an evaluation or during a meal-kit shopping session when the meal-kit card 350 is included in a published final menu.

The image(s) 359 is or references an image or set of images to be displayed when the meal-kit card 350 is displayed by the evaluator 104, server 106, client 110, and/or client 112. In some instances, there may be data associated with the image(s) 359 specifying attributes for the image(s), such as size, orientation, saturation, brightness, etc.

The recipe 361 is a set of textual instructions (e.g., a string) for preparing the meal-kit associated with the meal-kit card 350. The evaluator 104, server 106, client 110, and/or client 112 may reference the recipe 361 to display the recipe for the meal-kit during an evaluation or during a meal-kit shopping session when the meal-kit card 350 is included in a published final menu.

The price 363 identifies a price for the meal-kit associated with the meal-kit card 350. The price 363 may be any suitable variable type, such as a string, float, or integer. The evaluator 104, server 106, client 110, and/or client 112 may reference the price 363 to display the price of the meal-kit during an evaluation or during a meal-kit shopping session when the meal-kit card 350 is included in a published final menu.

The layout 365 is a data-set specifying the spatial layout and/or inclusion or exclusion of various components of the meal-kit card 350. For example, the layout 365 may specify the image 359 and the title 355 is to be displayed when the meal-kit card 350 is displayed. Alternatively, the layout 365 may specify that only the image 359 is to be displayed. In short, the layout 365 may specify any combination of the following to be displayed when the meal-kit card 350 is displayed: the title 355, the description 357, the image(s) 359, the recipe 361, and the price 363. Further, the layout 365 may specify how the selected components are organized relative to one another (e.g., specifying whether the image 359 is positioned above or below the title 355, specifying a position on the card for the description 357, etc.).

For each of the text items described above, there may be data specifying attributes for the text, such as font, font size, color, etc.

### IV. Example Menu Variants

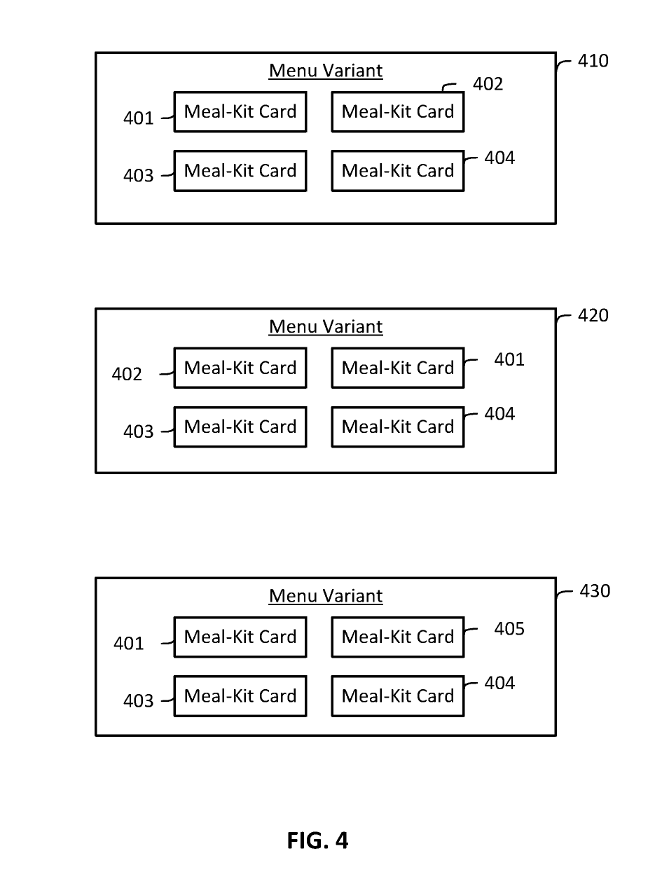

FIG. 4 depicts example menu variants 410, 420, and 430 that may be displayed via the customer client 112 of the system 100. The menu variants 410-30 are examples of the menu variants 133 shown in FIG. 1 and the meal-kit cards 401-405 are examples of the menu elements 131 shown in FIG. 1.

The menu variant 410 includes meal-kit cards 401-404. While the menu variant 420 includes the same meal-kit cards 401-404, it has a slightly different layout. The positions of meal-kit cards 401 and 402 have been swapped so that card 402 occupies the upper left hand position and so that card 401 occupies the upper right hand position.

The layout of the menu variant 430 is identical to the layout of menu variant 410, except a card 405 has been substituted for the card 402. The card 405 may represent an entirely different meal-kit than that represented by the card 402, or it may represent the same meal-kit as that represented by card 402 (e.g., the cards 402 and 405 may represent different “versions” of the same card).

In example operation, the menu variants 410-430 are transmitted to a plurality of respondent clients 110. Each respondent client 110 displays each of the menu variants 410-430 (e.g., via a browser window), and for each variant 410-430, a respondent selects which of the meal-kit cards he or she might purchase. The respondent selections are then transmitted to the evaluator 104.

By analyzing the respondent selections for each of the different variants 410-430, the evaluator 104 can determine which menu elements have the most impact on respondent selections of meal-kits. Impact may be measured using any of a variety of conversion metrics, as discussed at the beginning of the detailed description.

For example, an analysis of the selections for variants 410 and 420 might reveal that 20% total more meal-kits are selected from variant 410 than variant 420. Because the layout is the only difference between variants 410 and 420, the layout of variant 410 can be identified as preferable. The evaluator 104 may further evaluate multiple permutations of the layout to identify the ideal layout for meal-kit cards 401-404.

As another example, an analysis of the selection for variants 410 and 430 might reveal that 10% more total profit would be generated via the selections associated with the variant 430. Because the variants 410 and 430 are identical aside from the substitution of card 405 for card 402, the increased profit can likely be attributed to the card 405.

The evaluator 104 may engage in further testing of menu variants based on the results of a previous analysis. For example, in the previous example, the evaluator 104 may evaluate a number of different layouts using cards 401, 403, 404, and 405 after determining card 405 results in more profitable selections than card 402.

In some instances, a menu variant evaluated by the evaluator 104 consists of only a single meal-kit card. The evaluator 104 may thus evaluate respondent selections associated with numerous different meal-kit cards (or even with different versions of meal-kit cards representing the same meal-kit) to identify the meal-kit cards (or meal-kit card versions) having the best conversion metric(s). In such an example, the meal-kit cards that perform best in isolation can be identified. In this way, the evaluator 104 can first identify an ideal set of meal-kit cards before evaluating different potential layouts for the identified meal-kit cards.

### V. Example Host for the Modules 102-106

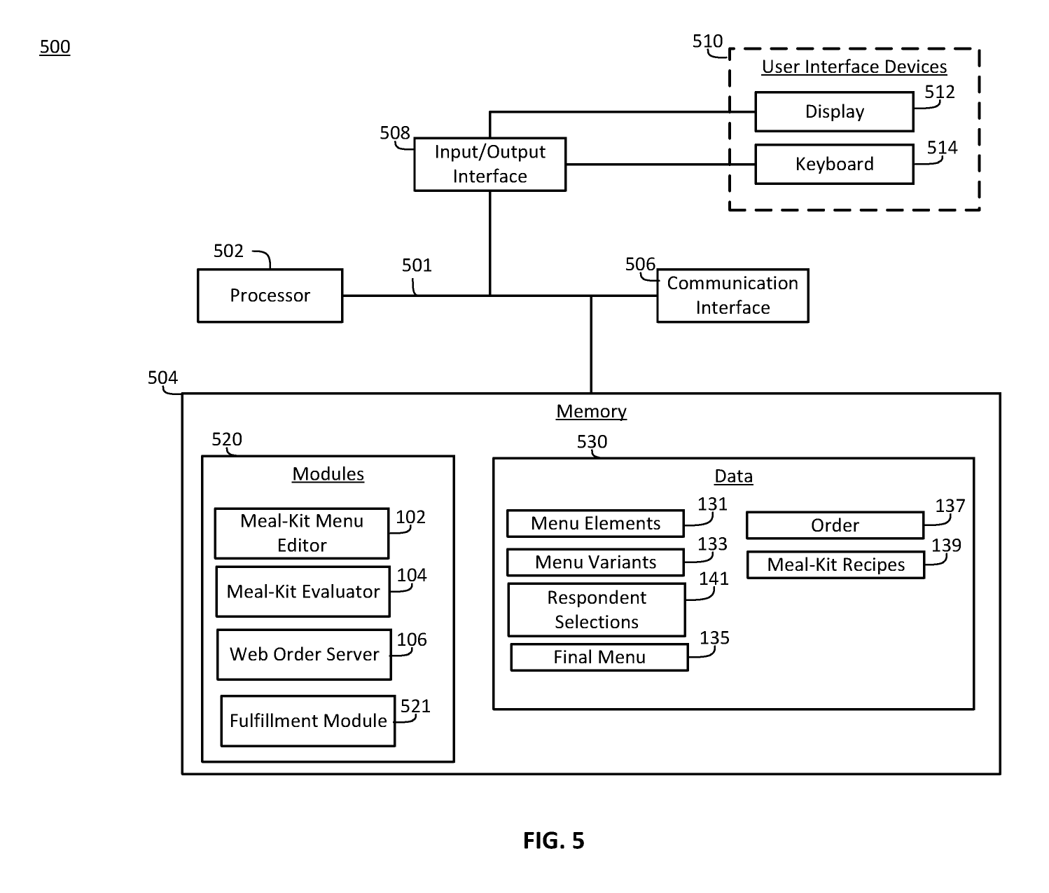

FIG. 5 is a block diagram of an example host 500 for the meal-kit menu editor 102, the meal-kit evaluator 104, and/or the web order server 106 of the system 100. The host 500 includes a system bus 501 communicatively coupling a processor 502, a memory 504, a communication interface 506, and an input/output (I/O) interface 508. The nature of each of these components is further described in the “Additional Considerations” section below. Next, the I/O interface 508, memory 504, and the operation of the host 500 are described in more detail.

The input/output (I/O) interface 508 may be communicatively coupled to one or more user interface (UI) devices 510, which the host 500 may rely on to provide output (e.g., visual or audio output) and to receive input (e.g., touch input or spoken input). As shown, the I/O interface 508 is communicatively coupled to a display 512 (e.g., via a wired or wireless link, such as a VGA link, an HDMI link, a wireless HDMI link, etc.) and to a keyboard 514 (e.g., via a wired or wireless link, such as a USB link, a PS/2 cable, a Bluetooth connection, etc.).

The memory 504 stores modules 520 and data 530. The modules 520 include the meal-kit menu editor 102, the meal-kit evaluator 104, and the web order server described with reference to FIG. 1. The data 530 include the menu elements 131, the menu variants 133, the final menu 135, the order 137, the meal-kit recipes 139, and the respondent selections 141 shown in FIG. 1.

Generally speaking, in operation of the host 500, the processor 502 fetches and executes instructions (such as those contained in the modules 520) stored to the memory 504. When the processor 502 executes the editor 102, the processor 502 causes the display 512 to display a tool for designing the menu variants 133. For example, the displayed tool may include a “library” including the menu elements 131 and a “drawing area” where a user can drag and drop (e.g., via a mouse connected to the I/O interface 508) selected menu elements from the library to design a menu variant 133. The user may save the menu variant 133 to the memory 504 by, for example, clicking a save button displayed in a title bar of the displayed tool.

When the processor 502 executes the meal-kit evaluator 104, the processor 502 may transmit one or more of the menu variants 133 to the respondent client 110 (shown in FIG. 1) via the communication interface 506. In response, the host 500 receives the respondent selections 141 (via the communication interface 506). After saving the respondent selections 141 to the memory 504, the processor 502 analyzes the respondent selections 141 and selects or generates the final menu 135 based on that analysis, as described with reference to FIG. 1.

When the processor 502 executes the web order server 106, the processor 502 causes the host 500 to communicate with the customer client 112 shown in FIG. 1 to provide a customer portal via the customer client 112. The processor 502 transmits the final menu 135 via the communication interface 506 to the customer client 112, where the final menu 135 is displayed via the customer portal. In some instances, the customer client 112 is a browser and the customer portal is provided via a window of the browser. The customer portal may look similar to the screenshot 200A shown in FIG. 2A. In some instances, the customer client 112 is an app (e.g., on a mobile device such as a tablet or a smart phone) that is specifically programmed to provide the customer portal. Regardless of the exact nature of the customer client 112, a user may select one or more meal-kits, and the customer client 112 may transmit those purchase selections to the host 500. The host 500 receives the purchase selections via the communication interface 506 and saves to the memory 504 the purchase selections as part of the order 137.

After the order 137 has been saved to the memory 504, it may be referenced to package the meal-kits included in the order. In particular, when the processor 502 executes the fulfillment module 521, the processor 502 may cause the display 512 to display a fulfillment tool. Warehouse workers may interact with the displayed fulfillment tool to learn the ingredients and/or items that should be packaged for a particular order. For example, if the order 137 includes purchase selections of three meal-kits out of twelve available meal-kit options, the module 521 may display the order 137 and the meal-kit recipes 139 associated with the three selected meal-kits. After the worker has packaged the ingredients as instructed for a particular order, the order may be shipped to the customer.

While FIG. 5 shows the host 500 implementing all four of the modules 102, 104, 106, and 521, it will be understood that in some instances the modules 102-106 and 521 may be implemented by two hosts, three hosts, or four hosts, depending on the embodiment. For example, each of the modules 102-106 and 521 may be implemented by a distinct host similar to the host 500.

In some instances, the I/O interface 508 is not connected to one or more of the display 512 and keyboard 514, and/or may be connected to other UI devices 510 not shown. For example, in some instances the UI devices 510 may include a touchscreen (e.g., with capacitive sensors for detecting touch input), a mouse, a microphone for receiving audio input, speakers for presenting audio output, motion sensing sensors (e.g., utilizing depth cameras and infrared projectors) to detect gesture input, or some combination thereof.

### VI. Example Host for the Client Modules 110 and 112

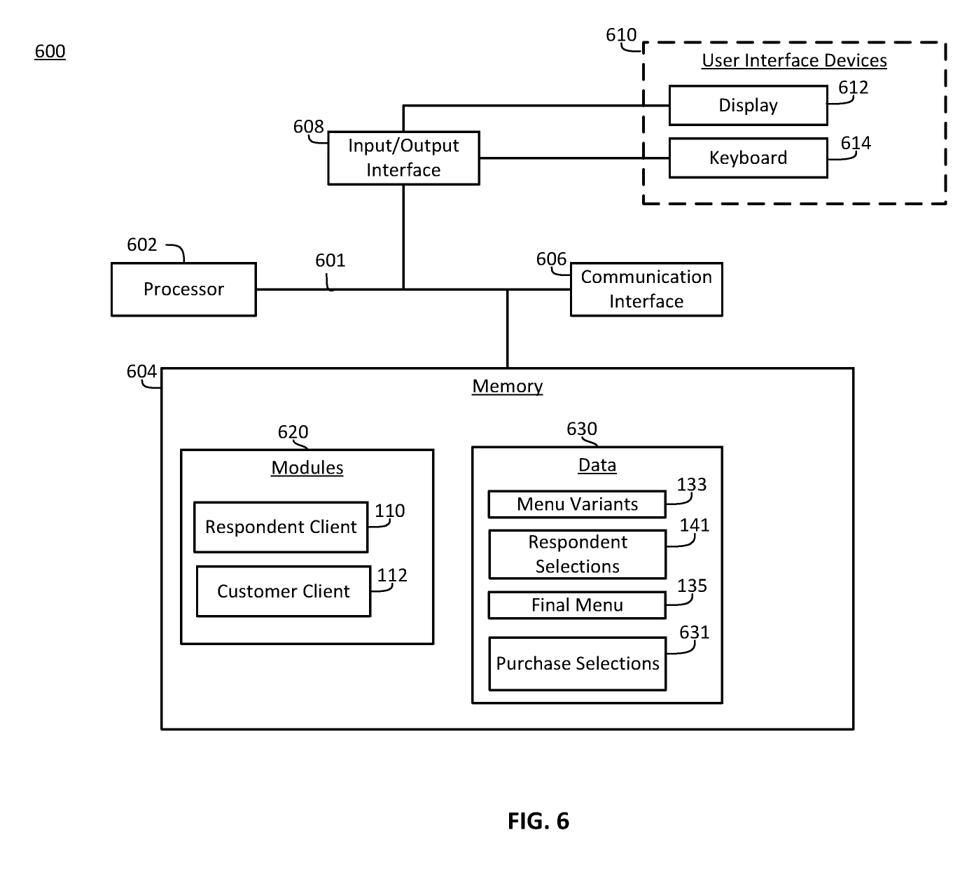

FIG. 6 is a block diagram of a host 600 for the respondent client 110 and/or the customer client 112 of the system 100. The host 600 includes a system bus 601 communicatively coupling a processor 602, a memory 604, a communication interface 606, and an input/output (I/O) interface 608. The nature of each of these components is further described in the “Additional Considerations” section below. The I/O interface 608 may be communicatively connected to UI devices 610, which are similar to the UI devices 510 shown in FIG. 5.

The memory 604 stores modules 620 and data 630. The modules 620 include the respondent client 110 and the customer client 112 shown in FIG. 1. The data 630 includes the menu variants 133, the respondent selections 141, and the final menu 135 shown in FIG. 1. The data 630 may also include purchase selections 631.

In example operation, when the processor 602 executes the respondent client 110, the host 600 may communicate with the meal-kit evaluator 104 to display a tool for presenting a survey of the menu variants 133. For example, the host 600 may receive the menu variants 133 via the communication interface 606 from the meal-kit evaluator 104 and may store the menu variants 133 at the memory 604. The processor 602 may then cause the display 612 to display each of the menu variants 133 via the display 612 and to receive (e.g., via the keyboard 614 or via another UI device 610 not shown, such as a mouse or touch sensor) user selections of one or more meal-kit options advertised on the menu variants 133. The processor 602 makes a record of the user selections by storing them to the memory 604 as the respondent selections 141. The processor 602 may transmit the respondent selections 141 to the evaluator 104 via the communication interface 606, where the respondent selections 141 can be analyzed.

When the processor 602 executes the customer client 112, the host 600 may communicate with the web order server 106 to display via the display 612 a customer portal for presenting the final menu 135 and for receiving user selections (e.g., via the keyboard 614 or via a UI device 610 not shown, such as mouse) of meal-kits to be purchased by the customer. The host 600 may receive the final menu 135 via the communication interface 606 from the web order server 106 and may store the final menu 135 to the memory 604. The processor 602 may make a record of the user selections by storing them to the memory 604 as the purchase selections 631. The processor 602 may transmit the purchase selections 631 via the communication interface 606 to the web order server 106.

While FIG. 6 shows the host 600 implementing both of the clients 110 and 112, it will be understood that in some instances the clients 110 and 112 are implemented by two distinct hosts similar to the host 600. A host implementing the client 110 may be referred to as a “respondent client device” or something similar, and a host implementing the client 112 may be referred to as the “customer client device” or something similar. The system 100 may include one or more respondent client devices and/or one or more customer client devices.

### VII. Additional Considerations

Although this detailed description contemplates various embodiments, it should be understood that the legal scope of any claimed system or method is defined by the words of the claims set forth at the end of this patent. This detailed description is to be construed as exemplary only and does not describe every possible embodiment, as describing every possible embodiment would be impractical, if not impossible.

Throughout this specification, plural instances may implement components, operations, or structures described as a single instance. Although individual operations of one or more methods are illustrated and described as separate operations, one or more of the individual operations may be performed concurrently in certain embodiments.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This description, and the claims that follow, should be read to include one or at least one. The singular also includes the plural unless it is obvious that it is meant otherwise.

In various embodiments, hardware systems described herein may be implemented mechanically or electronically. For example, a hardware system may comprise dedicated circuitry or logic that is permanently configured (e.g., as a special-purpose processor, such as a field programmable gate array (FPGA) or an application-specific integrated circuit (ASIC) to perform certain operations). A hardware system may also comprise programmable logic or circuitry (e.g., as encompassed within a general-purpose processor or other programmable processor) that is temporarily configured by software to perform certain operations. It will be appreciated that the decision to implement a hardware system mechanically, in dedicated and permanently configured circuitry, or in temporarily configured circuitry (e.g., configured by software) may be driven by cost and time considerations.

Throughout this specification, some of the following terms are used.

Bus. Generally speaking, a processor or a particular system or subsystem may communicate with other components of the system or subsystem via one or more communication links. When communicating with components in a shared housing, for example, the processor may be communicatively connected to components by a system bus. Unless stated otherwise, as used herein the phrase “system bus” and the term “bus” refer to: a data bus (for carrying data), an address bus (for determining where the data should be sent), a control bus (for determining the operation to execute), or some combination thereof. Depending on the context, “system bus” or “bus” may refer to any of several types of bus structures including a memory bus or memory controller, a peripheral bus, or a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Communication Interface. Some of the described devices and/or systems include a “communication interface” (sometimes referred to as a “network interface”). A communication interface of a system enables the system to send information or data to other system and/or receive information/data from other systems. In some instances, a communication interface of a system may be utilized to establish a direct connection to another system. In some instances, a communication interface of a system enables the system to connect to a network (via a link).

To illustrate, the described communication interfaces may include circuitry for permitting wireless communication (e.g., short-range and/or long-range communication) and/or wired communication with one or more devices or systems using any suitable communications protocol. For example, the communication interfaces may support Wi-Fi (e.g., an 802.11 protocol), Ethernet, Bluetooth, high frequency systems (e.g., 900 MHZ, 2.4 GHZ, and 5.6 GHZ communication systems), infrared, transmission control protocol/internet protocol (“TCP/IP”) (e.g., any of the protocols used in each of the TCP/IP layers), hypertext transfer protocol (“HTTP”), BitTorrent, file transfer protocol (“FTP”), real-time transport protocol (“RTP”), real-time streaming protocol (“RTSP”), secure shell protocol (“SSH”), any other communications protocol, or any combination thereof. The communication interfaces may also include circuitry that enables the larger system or host to be electrically or optically coupled to another device (e.g., via a coax cable or fiber optic cable) and to communicate with that other device.

Communication Link. A “communication link” or “link” is a pathway or medium connecting two or more nodes. A link may be a physical link and/or a logical link. A physical link is the interface and/or medium(s) over which information is transferred, and may be wired or wireless in nature. Examples of physicals links may include a cable with a conductor for transmission of electrical energy, a fiber optic connection for transmission of light, and/or a wireless electromagnetic signal that carries information via changes made to one or more properties of an electromagnetic wave(s).

A logical link between two or more nodes represents an abstraction of the underlying physical links and/or intermediary nodes connecting the two or more nodes. For example, two or more nodes may be logically coupled via a logical link. The logical link may be established via any combination of physical links and intermediary nodes (e.g., routers, switches, or other networking equipment).

A link is sometimes referred to as a “communication channel.” In a wireless communication system, the term “communication channel” (or just “channel”) generally refers to a particular frequency or frequency band. A carrier signal (or carrier wave) may be transmitted at the particular frequency or within the particular frequency band of the channel. In some instances, multiple signals may be transmitted over a single band/channel. For example, signals may sometimes be simultaneously transmitted over a single band/channel via different sub-bands or sub-channels. As another example, signals may sometimes be transmitted via the same band by allocating time slots over which respective transmitters and receivers use the band in question.

Input/Output (I/O) Interface. Some of the described devices and/or systems include an “I/O interface.” Generally speaking, an “I/O interface” of a system enables the system to send information to and/or receive information from a user interface device (e.g., a keyboard, mouse, display, etc.) and/or other peripheral devices (e.g., a scanner or printer). Depending on the embodiment, the I/O interface may establish wired (e.g., USB) or wireless links (e.g., via a wireless personal area network such as Bluetooth) with other devices.

Memory and Computer-Readable Media. Generally speaking, as used herein the phrase “memory” or “memory device” refers to a system or device including computer-readable media (“CRM”). “CRM” refers to a medium or media accessible by the relevant computing system for placing, keeping, and/or retrieving information (e.g., data, computer-readable instructions, program modules, applications, routines, etc). Note, “CRM” refers to media that is non-transitory in nature, and does not refer to disembodied transitory signals, such as radio waves.

The CRM may be implemented in any technology, device, or group of devices included in the relevant computing system or in communication with the relevant computing system. The CRM may include volatile and/or nonvolatile media, and removable and/or non-removable media. The CRM may include, but is not limited to, RAM, ROM, EEPROM, flash memory, or other memory technology, CD-ROM, digital versatile disks (DVD) or other optical disk storage, magnetic cassettes, magnetic tape, magnetic disk storage or other magnetic storage devices, or any other medium which can be used to store information and which can be accessed by the computing system. The CRM may be communicatively coupled to a system bus, enabling communication between the CRM and other systems or components coupled to the system bus. In some implementations the CRM may be coupled to the system bus via a memory interface (e.g., a memory controller). A memory interface is circuitry that manages the flow of data between the CRM and the system bus.

Network. As used herein and unless otherwise specified, when used in the context of system(s) or device(s) that communicate information or data, the term “network” refers to a collection of nodes (e.g., devices or systems capable of sending, receiving and/or forwarding information) and links which are connected to enable telecommunication between the nodes.

A network may include dedicated routers responsible for directing traffic between nodes, and, optionally, dedicated devices responsible for configuring and managing the network. Some or all of the nodes may be also adapted to function as routers in order to direct traffic sent between other network devices. Network devices may be inter-connected in a wired or wireless manner, and network devices may have different routing and transfer capabilities. For example, dedicated routers may be capable of high volume transmissions while some nodes may be capable of sending and receiving relatively little traffic over the same period of time. Additionally, the connections between nodes on a network may have different throughput capabilities and different attenuation characteristics. A fiberoptic cable, for example, may be capable of providing a bandwidth several orders of magnitude higher than a wireless link because of the difference in the inherent physical limitations of the medium. A network may include networks or sub-networks, such as a local area network (LAN) or a wide area network (WAN).

Node. Generally speaking, the term “node” refers to a connection point, redistribution point, or a communication endpoint. A node may be any device or system (e.g., a computer system) capable of sending, receiving and/or forwarding information. For example, end-devices or end-systems that originate and/or ultimately receive a message are nodes. Intermediary devices that receive and forward the message (e.g., between two end-devices) are also generally considered to be “nodes.”

Processor. The various operations of example methods described herein may be performed, at least partially, by one or more processors. Generally speaking, the terms “processor” and “microprocessor” are used interchangeably, each referring to a computer processor configured to fetch and execute instructions stored to memory. By executing these instructions, the processor(s) can carry out various operations or functions defined by the instructions. The processor(s) may be temporarily configured (e.g., by instructions or software) or permanently configured to perform the relevant operations or functions (e.g., a processor for an Application Specific Integrated Circuit, or ASIC), depending on the particular embodiment. A processor may be part of a chipset, which may also include, for example, a memory controller and/or an I/O controller. A chipset is a collection of electronic components in an integrated circuit that is typically configured to provide I/O and memory management functions as well as a plurality of general purpose and/or special purpose registers, timers, etc. Generally speaking, one or more of the described processors may be communicatively coupled to other components (such as memory devices and I/O devices) via a system bus.

The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

Words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

What is claimed is:

1. A system comprising:
(A) a meal-kit menu evaluator including a processor and a memory storing computer readable instructions that, when executed by the processor, cause the meal-kit menu evaluator to:
(i) transmit a plurality of meal-kit menu variants to a first plurality of client devices for display at the first plurality of client devices;
(ii) receive response data from the first plurality of client devices, the response data representing user selections at the first plurality of client devices of one or more meal-kits advertised in the plurality of meal-kit menu variants;
(iii) analyze the user selections to calculate a plurality of values of a conversion metric, the plurality of values including a value for each of the plurality of meal-kit menu variants; and
(iv) select, from the plurality of meal-kit menu variants and based on the plurality of values of the conversion metric, a meal-kit menu variant to be a final meal-kit menu; and
(B) a web ordering system including a processor and a memory storing computer readable instructions that, when executed by the processor, cause the web ordering system to:
(i) transmit the final meal-kit menu to a second plurality of client devices where the final meal-kit menu is displayed;
(ii) receive, from one of the second plurality of client devices, a selection for purchase of one or more meal-kits advertised in the final meal-kit menu; and
(iii) generate an order record identifying the one or more meal-kits selected for purchase, the order record referenceable to identify meal-kit components to be delivered for the one or more meal-kits selected for purchase.

2. The system of claim 1, further including: a menu editor tool that generates the plurality of meal-kit menu variants.

3. The system of claim 2, wherein the menu editor tool generates each of the plurality of meal-kit menu variants based on a user selecting one or more menu elements to be included in the meal-kit menu variant.

4. The system of claim 1, wherein each of the first plurality of client devices receives a single one of the plurality of meal-kit menu variants.

5. The system of claim 1, wherein each of the first plurality of client devices receives multiple ones of the plurality of meal-kit menu variants.

6. The system of claim 1, wherein each of the plurality of meal-kit menu variants includes menu elements, the menu elements including meal-kit cards.

7. The system of claim 6, wherein at least one of the plurality of meal-kit menu variants include a set of menu elements that is unique with respect to the others of the plurality of meal-kit menu variants.

8. The system of claim 6, wherein the plurality of meal-kit menu variants includes:
(i) a first meal-kit menu variant that includes a particular set of menu elements laid out according to a first layout; and
(ii) a second meal-kit menu variant that includes the particular set of menu elements laid out according to a second layout.

9. The system of claim 1, wherein the conversion metric is a number of meal-kits selected.

10. The system of claim 1, wherein the conversion metric is selected from the group consisting of: total projected sales revenue for meal-kits selected; total projected profit for selected meal-kits selected; and some combination thereof.

11. A method comprising:
(A) generating, at a menu editor, a plurality of meal-kit menu variants;
(B) evaluating, at a meal-kit evaluator, the plurality of meal-kit menu variants by:
(i) transmitting the plurality of meal-kit menu variants to a first plurality of client devices for display at the first plurality of client devices;
(ii) at each of the first plurality of client devices, displaying at least one of the plurality of meal-kit menu variants;
(iii) receiving, at the meal-kit evaluator, response data from the first plurality of client devices, the response data representing user selections of one or more meal-kits advertised in the plurality of meal-kit menu variants;
(iv) analyzing, at the meal-kit evaluator, the user selections to calculate a plurality of values of a conversion metric, the plurality of values including a value for each of the plurality of meal-kit menu variants;
(C) selecting, from the plurality of meal-kit menu variants and based on the plurality of values of the conversion metric, a meal-kit menu variant to be a final meal-kit menu;
(D) electronically transmitting, from a web ordering system, the final meal-kit menu to a second plurality of client devices;
(E) displaying, via an electronic display of a client device from the second plurality of client devices, the final meal-kit menu;
(F) receiving, via an input interface of the client device, a selection for purchase from a user of one or more meal-kits advertised in the final meal-kit menu; and
(G) generating, via the web ordering system, an order record identifying the one or more meal-kits selected for purchase, the order record referenceable to identify meal-kit components to be delivered for the one or more meal-kits selected for purchase.

12. The method of claim 11, wherein displaying, at each of the first plurality of client devices, at least one of the plurality of meal-kit menu variants comprises: displaying a single one of the plurality of meal-kit menu variants.

13. The method of claim 11, wherein displaying, at each of the first plurality of client devices, at least one of the plurality of meal-kit menu variants comprises: displaying multiple ones of the plurality of meal-kit menu variants.

14. The method of claim 11, wherein each of the plurality of meal-kit menu variants includes menu elements, the menu elements including meal-kit cards.

15. The method of claim 14, wherein at least one of the plurality of meal-kit menu variants include a set of menu elements that is unique with respect to the others of the plurality of meal-kit menu variants.

16. The method of claim 14, wherein the plurality of meal-kit menu variants includes
(i) a first meal-kit menu variant that includes a particular set of menu elements laid out according to a first layout; and
(ii) a second meal-kit menu variant that includes the particular set of menu elements laid out according to a second layout.

17. The method of claim 11, wherein the conversion metric is a number of meal-kits selected.

18. The method of claim 11, wherein the conversion metric is selected from the group consisting of: total projected sales revenue for selected meal-kits; total projected profit for selected meal-kits; and some combination thereof.

19. The method of claim 11, wherein analyzing, at the meal-kit evaluator, the user selections to identify the value of the conversion metric for each of the plurality of meal-kit menu variants comprises:
identifying multiple pairs from the plurality of meal-kit menu variants, and
for each pair, comparing a first meal-kit menu variant from the pair to a second meal-kit menu variant from the pair.

20. The method of claim 19, wherein the first meal-kit menu variant and the second meal-kit menu variant differ only by a single menu element; and
wherein the method further includes storing to memory a record indicating a correlation between the single menu element and the difference in the values of the conversion metric for the first meal-kit menu variant and the second meal-kit menu variant.
